(19) United States
(12) Patent Application Publication
(10) Pub. No.: US 2016/0045849 A1
(43) Pub. Date: Feb. 18, 2016

(54) Explosion Protection Device

(71) Applicant: Keller Lufttechnik GmbH + Co. KG, Kirchheim/Teck (DE)

(72) Inventors: Ulrich Stolz, Kirchheim unter Teck (DE); Jens Kuhn, Gammelshausen (DE); Morris Koch, Kirchheim unter Teck (DE); Norbert Frank, Dettingen/Teck (DE)

(21) Appl. No.: 14/828,536

(22) Filed: Aug. 18, 2015

(30) Foreign Application Priority Data
Aug. 18, 2014 (DE) 202014103813.2
Sep. 17, 2014 (DE) 202014104404.3

(51) Int. Cl. B01D 46/00

(52) U.S. Cl. CPC B01D 46/0019; B01D 2257/60

(57) ABSTRACT

The explosion protection device as per the invention is intended to be used for a system located in a closed room whose components are located in a housing. A housing opening is provided in a side wall of the housing that connects to a redirection unit, which effects an upward redirection of a gas stream escaping from the housing opening when an explosion occurs in the housing. The redirection unit has an outlet opening on which a flame-retardant relief device is arranged. The redirection unit is connected to a protective shield that surrounds the outlet opening.

### CROSS-REFERENCE TO RELATED APPLICATIONS

This application claims the benefit under 35 USC 119 of German patent applications DE 20 2014 103 813.2 filed on Aug. 18, 2014 and DE 20 2014 104 404.3 filed on Sep. 17, 2014; all applications are incorporated by reference herein in their entirety.

### BACKGROUND

The invention relates to an explosion protection device.

Explosion protection devices of this type are used in different kinds of equipment and especially in filtering systems.

Particles that have a high risk of explosion can, in particular, also be separated out with filtering systems of the type under discussion. An example of this is the separation of metallic dust, especially aluminum, magnesium or titanium dust.

If an explosion arises in the housing of a filtering system of this type, it can lead to serious personal injury and damage.

To avoid these kinds of risks, the filtering systems and the associated processing plants on which particles that create an explosion hazard can arise were put outside in the past.

That is not efficient, however, because these units are separated from other processing plants located in buildings, especially in factory halls. It is therefore desirable to also equip these filtering systems or systems in general with explosion protection devices so that they can be used in closed rooms like factory halls.

A explosion protection device of that type is known from DE 10 2012 102 468. The explosion protection device described there involves a relief element arranged on a partition wall that brings about a reduction in pressure when an explosion occurs in the room by discharging a gas stream from the room through the device. An enclosure is connected to the partition wall; at least one flame arrester is arranged in it. The enclosure is designed in such a way that a gas stream flowing out of the relief element is carried along in the enclosure and passes through the flame arrester in the process.

Flameless pressure reduction is achieved with this explosion protection device that avoids an uncontrolled escape of flames with a high level of reliability in a room to be protected when explosions occur.

A drawback here, however, is that this explosion protection device is limited to relatively small volume flows and can therefore only be used for correspondingly small systems. This is based on the fact that the enclosure can only accommodate relatively small volume flows.

### SUMMARY

The explosion protection device (2) as per the invention is intended to be used for a system located in a closed room whose components are located in a housing (4). A housing opening is provided in a side wall of the housing (4) that connects to a redirection unit (8), which effects an upward redirection of a gas stream escaping from the housing opening when an explosion occurs in the housing. (4) The redirection unit (8) has an outlet opening on which a flame-retardant relief device (10) is arranged. The redirection unit (8) is connected to a protective shield (11) that surrounds the outlet opening.

### DETAILED DESCRIPTION

The invention is based on the task of providing an explosion protection device of the type mentioned at the outset via which efficient flame protection is also achieved when greater volume flows arise in the case of an explosion.

The elements of claim 1 are specified to solve this problem. Advantageous embodiments and useful design developments of the invention are described in the sub-claims.

The explosion protection device as per the invention is intended to be used for a system located in a closed room whose components are located in a housing. A housing opening is provided in a side wall of the housing that connects to a redirection unit, which effects an upward redirection of a gas stream escaping from the housing opening when an explosion occurs in the housing. The redirection unit has an outlet opening on which a flame-retardant relief device is arranged. The redirection unit is connected to a protective shield that surrounds the outlet opening.

An important advantage of the invention is that, because of the explosion protection device, the system protected by it can also be used inside without danger, meaning in closed rooms like factory halls.

In particular, it is advantageous that reliable explosion protection is also achieved with the explosion protection device as per the invention for large systems, in which large volume flows can arise in the case of an explosion.

These advantages are achieved in a surprisingly simple way in that the gas stream arising in the system in the case of an explosion is discharged out of the system laterally via a housing opening and is fed into a flame-retardant relief device through a redirection unit. An additional enclosure, especially for the flame-retardant relief device, is not required. This is based on the fact, for one thing, that the redirection unit diverts the gas stream upwards and keeps it away from the occupied area of a closed room where people could be. This effect is also reinforced as per the invention by the protective shield protruding in front of the redirection unit.

Since hot gases escaping from the flame-retardant relief device are kept out of the occupied area of the room, meaning the area where people could be or where dangerous systems or substances could also be, with the redirection unit and also with the protective shield, an enclosure that limits the processing volume flow of gases that arise in an explosion is not necessary.

The outlet opening is advantageously located above an occupied area of that type in a closed room.

This is achieved by a suitable mounting of the housing opening in the housing of the system and a suitable dimensioning of the redirection unit. Keeping the hot gases escaping from the flame-retardant relief device from being able to spread out downwards has to then merely be avoided with the protective shield when there is an explosion.

The protective shield advantageously opens out on the edge at the top of the redirection unit in which the outlet opening is located. The protective shield thereby runs at a distance from the flame-retardant relief device.

The protective shield then forms a redirection element for gases flowing out of the flame-retardant relief device to the effect that they are diverted upwards and that a dangerous spread of gases downwards into the occupied area is avoided.

The protective shield does not have to extend over the entire height of the flame-retardant relief device to achieve this effect. Instead, the flame-retardant relief device can protrude over the upper edge of the protective shield.

It is especially advantageous when the protective shield has the shape of a collar. In particular, the collar has the form of a funnel that expands upwards.

In accordance with an embodiment of the invention that is advantageous with regard to the design, the gas stream that arises when there is an explosion in a horizontal direction at the housing opening is diverted via the redirection unit in such a way that it passes through the outlet opening of the redirection unit, running upwards in a vertical direction.

These gas streams are already kept out of the occupied area in the lower area of the closed room in which the system is located with this routing of the gas streams.

It is advantageous when the redirection unit is a hollow body with a closed surface shell with the outlet opening connected to one end of it.

It is ensured via the closed surface shell of the redirection unit that the entire gas stream will run through the housing opening and the outlet opening of the flame-retardant relief device when there is an explosion. Furthermore, there are advantageous provisions here for the flame-retardant relief device to be set upon the outlet opening and seal it up.

The hollow body forming the redirection unit has an opening corresponding to the housing opening at one end.

The opening of the redirection unit consequently directly adjoins the housing opening and is not blocked by other elements. In particular, there is no rupture disk or the like there. An additional explosion protection element of that type would be counterproductive, because the space in the redirection unit would be abruptly filled with the outflowing gas stream in the case that the rupture disk bursts when an explosion arises, which would involve the risk that a secondary explosion could arise there in an uncontrolled fashion.

In accordance with an advantageous embodiment of the invention, the system is a filtering system. In particular, the filtering system is designed to separate out metallic dust. The filtering system has an arrangement of dry filters for this.

Because of the use of the explosion protection device as per the invention in filtering systems of that type, processing plants, especially in the automotive area where metallic dust at risk of an explosion arises during the processing of parts make of metal, especially aluminum, magnesium or titanium, can be used in closed rooms.

### BRIEF DESCRIPTION OF THE DRAWINGS

The invention will be explained with the aid of the drawings below. The following are shown in the figures:

FIG. 1: Design example of the explosion protection device as per the invention in a filtering system in an isometric view.

FIG. 2: Side view of the arrangement in accordance with FIG. 1.

### DETAILED DESCRIPTION OF THE PREFERRED EMBODIMENTS

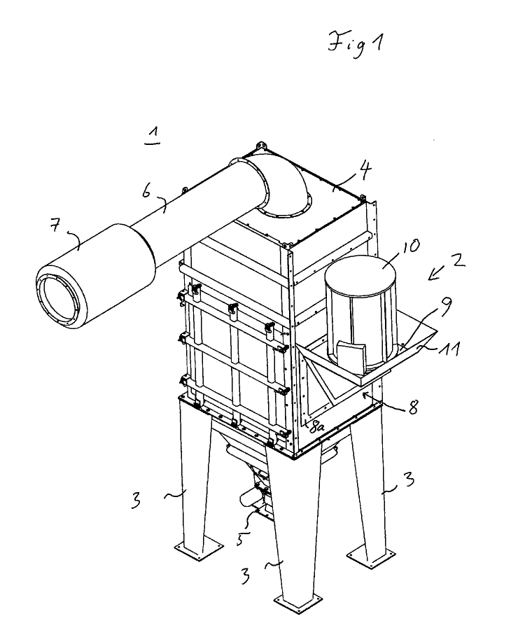

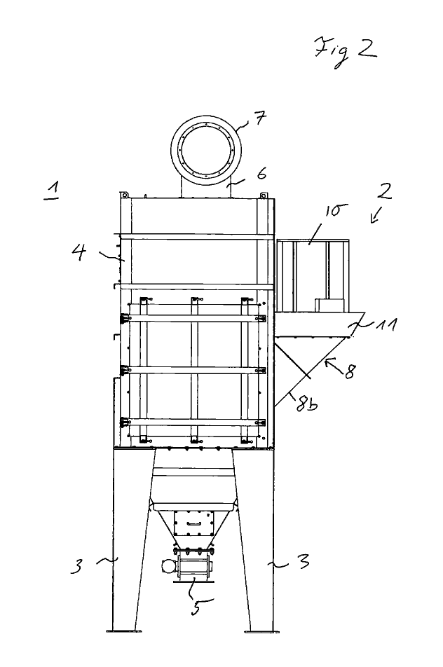

FIGS. 1 and 2 show a filtering system 1 with an explosion protection device 2 as per the invention arranged on it. The filtering system 1 has a housing 4 situated on support legs 3; the filter elements of the filtering system 1 are arranged in the housing 4. The housing 4 is made of a metallic material. The filter elements arranged in the interior of the housing 4 are not visible in FIGS. 1 and 2.

In this case, the filtering system 1 has an arrangement of dry filters, especially cartridge filters. An outlet device 5 opens out on the bottom of the housing 4. Dust separated by the dry filters, which is collected in containers in the housing 4 if necessary after the dry filters are dedusted, is discharged from the filtering system 1 through it. An outlet line 6 comprised of pipes via which gas streams purified in the filtering system 1 are discharged open out at the top of the housing 4. A muffler 7 is located at the end of the outlet line 6.

The filtering system 1 is located in a closed room, especially in a factory hall; the filtering system 1 is positioned in the area of a processing plant or the like in order to separate out air contamination that arises there. In so doing, the filtering system 1 stands on its support legs 3 on the floor of the factory hall. In particular, the filtering system 1 serves to filter metallic dust from gas streams that are fed in from the area of the processing plant with a piping system of the filter system 1. The dust is comprised, in particular, of metals creating the risk of an explosion such as aluminum, magnesium or titanium.

The explosion protection device 2 is provided on the filtering system 1 to protect the filtering system 1 in the case of an explosion.

The explosion protection device 2 has a redirection unit 8 as a first component. The redirection unit 8 is preferably made up of a hollow body comprised of a metallic material.

This redirection unit 8 is laterally mounted to a housing opening on the housing 4 of the filtering system 1. The redirection unit 8 has an opening bounded by an edge strip 8a at one end. The redirection unit 8 is fastened to the housing 4 with the edge strip 8a.

The closed surface shell of the redirection unit 8 has a wall segment 8b opposite the opening that runs at a tilt of 45° vis-a-vis the plane of the opening.

If an explosion arises in the housing 4, the gas stream that arises will therefore be routed through the housing opening in the redirection unit 8 and then diverted vertically upwards at the wall element.

A base element 9 in which a central circular outlet opening is provided is located on the top of the redirection unit 8. A flame-retardant relief device 10 rests on this outlet opening as a further component of the explosion protection device 2; the flame-retardant relief device 10 tightly seals up the outlet opening.

The outlet opening runs in a horizontal plane. The flame-retardant relief device 10 has a cylindrical shape; the longitudinal axis of the flame-retardant relief device 10 is oriented in a vertical direction.

The flame-retardant relief device 10 has a flame trap made of stainless steel with an upstream rupture disk.

When an explosion occurs, the gas stream, after going into the redirection unit 8, is routed through the housing opening and through the outlet opening of the flame-retardant relief device 10. The flames existing in the gas stream are accommodated there, meaning that flames do not escape from the explosion protection device 2. Furthermore, the pressure wave of the gas stream is weakened in the flame-retardant relief device 10, so only a weakened, hot gas stream is discharged through the surface shell of the flame-retardant relief device 10.

It is ensured, because of the lateral mounting of the housing opening at a relatively great height over the floor and because of the operation of the redirection unit 8 to the effect that it diverts the gas stream arising in an explosion upwards, that the gas stream weakened by the flame-retardant relief device 10 leaves it at a great height and therefore above the occupied area around the floor of the factory hall, where there are people and where metallic dust, in particular, could still exist.

A protective shield 11 is connected as per the invention to the top of the redirection unit 8 to prevent the gas stream escaping from the flame-retardant relief device 10 from being able to flow downwards.

The protective shield 11 is designed in this case to be a collar that has the shape of a funnel that expands upwards. It is advantageous when the protective shield 11 is comprised of the same material as the redirection unit 8.

The protective shield 11 opens out at the upper edge of the redirection unit 8 and runs, starting from there, upwards at a tilt and consequently laterally protrudes over the redirection unit 8. The protective shield 11 extends over the entire edge of the redirection unit 8 and is firmly connected to the side wall of the housing 4 at one end. As evident from FIG. 1, the protective shield 11 runs at a distance to the flame-retardant relief device 10. The height of the protective shield 11 is lower than the height of the flame-retardant relief device 10.

All of the gas-stream components that escape from the flame-retardant relief device 10 and that are aimed downwards are carried off and diverted upwards by the protective shield 11. A situation in which components of the gas stream escaping from the flame-retardant relief device 10 are able to flow downwards into the occupied area is therefore avoided in a simple way.

The explosion protection device 2 that is designed in this way therefore makes do without its own enclosure and can consequently be used for plants in which large gas volume flows arise when there is an explosion.

### LIST OF REFERENCE NUMERALS

(1) Filtering system

(2) Explosion protection device

(3) Support legs

(4) Housing

(5) Outlet device

(6) Outlet line

(7) Muffler

(8) Redirection unit

(8a) Edge strip

(8b) Wall segment

(9) Base unit

(10) Flame-retardant relief device

(11) Protective shield

1. Explosion protection device (2) for a system located in a closed room, whose components are arranged in a housing (4), characterized in that a housing opening is provided in a side wall of the housing (4), said housing opening connecting to a redirection unit (8) that diverts a gas stream escaping from the housing opening upwards in the case of an explosion in the housing (4), that the redirection unit (8) has an outlet opening on which a flame-retardant relief device (10) is arranged and that a protective shield (11) surrounding the outlet opening is connected to the redirection unit (8).

2. Explosion protection device (2) according to claim 1, characterized in that the gas stream arising in an explosion is diverted in a horizontal direction at the housing opening via the redirection unit (8) in such a way that it passes through the outlet opening of the redirection unit (8), running upwards in a vertical direction.

3. Explosion protection device (2) according to claim 1, characterized in that the redirection unit (8) is a hollow body with a closed surface shell and that the outlet opening is connected to an end of said hollow body.

4. Explosion protection device (2) according to claim 3, characterized in that the hollow body forming the redirection unit (8) has an opening corresponding to the housing opening at one end.

5. Explosion protection device (2) according to claim 1, characterized in that the outlet opening is located above an occupied area in the closed room.

6. Explosion protection device (2) according to claim 1, characterized in that the flame-retardant relief device (10) rests on the outlet opening and seals it up tight.

7. Explosion protection device (2) according to claim 1, characterized in that the protective shield (11) opens out at the edge on the top of the redirection unit (8) on which the outlet opening is located.

8. Explosion protection device (2) according to claim 1, characterized in that the protective shield (11) runs at a distance to the flame-retardant relief device (10).

9. Explosion protection device (2) according to claim 1, characterized in that the flame-retardant relief device (10) protrudes beyond the upper edge of the protective shield (11).

10. Explosion protection device (2) according to claim 1, characterized in that the protective shield (11) has the shape of a collar.

11. Explosion protection device (2) according to claim 10, characterized in that the collar has the shape of a funnel expanding upwards.

12. Explosion protection device (2) according to claim 1, characterized in that the system is a filtering system (1).

13. Explosion protection device (2) according to claim 12, characterized in that the filtering system (1) is designed to separate out metallic dust.

14. Explosion protection device (2) according to claim 12, characterized in that the filtering system (1) has an arrangement of dry filters.
